(19) United States
(12) Patent Application Publication
(10) Pub. No.: US 2016/0255660 A1
(43) Pub. Date: Sep. 1, 2016

(54) STATION AND WIRELESS LINK CONFIGURATION METHOD THEREFOR

(71) Applicant: INTELLECTUAL DISCOVERY CO., LTD., Gangnam-gu (KR)

(72) Inventors: Ju Hyung SON, Uiwang-si (KR); Jin Sam KWAK, Uiwang-si (KR); Hyun Oh OH, Gwacheon-si (KR); Kuk Il LIM, Seoul (KR)

(73) Assignee: INTELLECTUAL DISCOVERY CO., LTD., Gangnam-gu (KR)

(21) Appl. No.: 15/152,069

(22) Filed: May 11, 2016

Related U.S. Application Data
(63) Continuation of application No. PCT/KR2014/010805, filed on Nov. 11, 2014.

(30) Foreign Application Priority Data
Nov. 11, 2013 (KR) 10-2013-0136087

(51) Int. Cl. H04W 76/00; H04W 72/04

(52) U.S. Cl. CPC H04W 76/002; H04W 72/0453; H04W 84/12

(57) ABSTRACT

A wireless link configuration method of a station is provided. The wireless link configuration method may include: sequentially transmitting a beamforming signal to each of at least one sector, wherein the beamforming signal includes a sector ID for identifying a predetermined sector; and receiving, from an external station, a feedback signal corresponding to at least one of the transmitted beamforming signals, wherein the beamforming signal is transmitted on a first frequency band and the feedback signal is received on a second frequency band.

### CROSS-REFERENCE TO RELATED APPLICATION

This application is a continuation application of PCT Application No. PCT/KR2014/010805 filed on Nov. 11, 2014, which claims the benefit of Korean Patent Application No. 10-2013-0136087 filed on Nov. 11, 2013, the entire disclosures of which are incorporated herein by reference.

### TECHNICAL FIELD

The present disclosure relates to a station and a wireless link configuration method therefor, and more particularly, to a method for configuring a wireless link between stations using multiple frequency bands.

### BACKGROUND

With the wide spread of mobile devices in recent years, a wireless LAN technology capable of providing fast wireless Internet services to such mobile devices has been attracting a lot of attention. The wireless LAN technology enables mobile devices, such as smart phones, smart pads, laptop computers, mobile multimedia players, and embedded devices, to be wirelessly connected to the Internet in a close distance at home or in a company or a specific service providing area.

The initial wireless LAN technology supported a speed of 1 Mbps to 2 Mbps by frequency hopping, spread spectrum, infrared ray communication, and the like using a frequency of 2.4 GHz through the Institute of Electrical and Electronics Engineers (IEEE) 802.11. Recently, the wireless LAN technology can support a speed of maximum 54 Mbps by applying orthogonal frequency division multiplex (OFDM). Besides, IEEE 802.11 is commercializing or developing standards for various technologies such as improvement of quality for service (QoS), access point (AP) protocol compatibility, security enhancement, radio resource measurement, wireless access vehicular environment, fast roaming, mesh network, interworking with an external network, and wireless network management.

Of IEEE 802.11, IEEE 802.11b supports a communication speed of maximum 11 Mbps by using a frequency of a 2.4 GHz band. IEEE 802.11a, which has been commercially used after IEEE 802.11b, reduced an influence of interference, as compared with the frequency of the significantly complicated 2.4 GHz band, by using a frequency of a 5 GHz band, instead of the 2.4 GHz band, and also improved the communication speed up to maximum 54 Mbps by using the OFDM technology. However, IEEE 802.11a has a drawback in that its communication distance is shorter than IEEE 802.11b. In addition, IEEE 802.11g has attracted a lot of attention since it realizes the communication speed of maximum 54 Mbps by using the frequency of the 2.4 GHz band like IEEE 802.11b, and satisfies backward compatibility. In terms of the communication distance, IEEE 802.11g is also superior to IEEE 802.11a.

Further, IEEE 802.11n was established as a technology standard to overcome the limit of the communication speed that has been considered as a weakness of the wireless LAN. The purpose of IEEE 802.11n is to increase a speed and reliability of a network and expand an operation distance of a wireless network. More specifically, IEEE 802.11n supports a high throughput (HT) with a data processing speed of maximum 540 Mbps or more, and is based on the multiple inputs and multiple outputs (MIMO) technology using multiple antennas in both ends of each of transmission and reception units in order to minimize transmission errors and optimize a data speed. Furthermore, this standard may use a coding method that transmits several overlapping copies in order to improve data reliability, or orthogonal frequency division multiplex (OFDM) in order to increase a speed.

As supply of the wireless LAN increases and applications using the wireless LAN are diversified, there has been recently an increasing need for a new wireless LAN system to support a higher throughput (very high throughput; VHT) than the data processing speed supported by IEEE 802.11n. Particularly, IEEE 802.11ac supports a broad bandwidth (80 MHz to 160 MHz) in the 5 GHz frequency. The IEEE 802.11ac standard is defined only for the 5 GHz band, but initial 11ac chipsets may also support the operation in the 2.4 GHz band for lower compatibility with existing 2.4 GHz-band products. In this case, 802.11ac supports a bandwidth of from 2.4 GHz to maximum 40 MHz. Theoretically, according to this standard, a wireless LAN speed of multiple devices can be at least 1 Gbps and a maximum single link speed can be at least 500 Mbps. This is realized by expanding wireless interface concepts, such as a broader radio frequency bandwidth (maximum 160 MHz), more MIMO spatial streams (maximum 8 streams), multiple user MIMO, and high-density modification (maximum 256 QAM), accepted in 802.11n. Further, there is IEEE 802.11ad, which transmits data by using a 60 GHz band, instead of existing 2.5 GHz/5 GHz. IEEE 802.11ad is a transmission standard for providing a speed of maximum 7 Gbps by using a beamforming technology, and suitable for high bit-rate video streaming such as large-scale data or uncompressed HD videos. However, the 60 GHz frequency band is disadvantageous in that it cannot easily pass through obstacles, and thus, can be used only for devices in a short-distance space.

### DISCLOSURE OF THE INVENTION

### Problems to be Solved by the Invention

The present disclosure is provided to efficiently perform wireless link configuration using multiple frequency bands.

More specifically, the present disclosure is provided to suggest an efficient method for selecting a beamforming sector between stations that conduct communication using a high-frequency band.

Further, the present disclosure is provided in order for stations that conduct communication using a directional signal to complete a sector sweep in a short time.

However, problems to be solved by the present disclosure are not limited to the above-described problems. There may be other problems to be solved by the present disclosure.

### Means for Solving the Problems

According to an aspect of the present disclosure, a wireless link configuration method of a station may include: sequentially transmitting a beamforming signal to each of at least one sector, wherein the beamforming signal includes a sector ID for identifying a predetermined sector; and receiving from an external station, a feedback signal corresponding to at least one of the transmitted beamforming signals, wherein the beamforming signal is transmitted on a first frequency band and the feedback signal is received on a second frequency band.

Further, according to another aspect of the present disclosure, a wireless link configuration method of a station may include: receiving at least one beamforming signal from an external station, wherein the beamforming signal includes a sector ID for identifying a predetermined sector of the external station; and transmitting at least one feedback signal to the external station in response to the at least one beamforming signal, wherein the beamforming signal is received on a first frequency band and the feedback signal is transmitted on a second frequency band.

Furthermore, according to yet another aspect of the present disclosure, a station may include: a processor that controls an operation of the station; and at least one network interface card that transmits or receives data on the basis of an instruction of the processor, wherein the processor sequentially transmits a beamforming signal to each of at least one sector, wherein the beamforming signal includes a sector ID for identifying a predetermined sector, the processor receives a feedback signal from an external station in response to at least one of the transmitted beamforming signals, and the beamforming signal is transmitted on a first frequency band and the feedback signal is received on a second frequency band.

Moreover, according to still another aspect of the present disclosure, a station may include: a processor that controls an operation of the station; and at least one network interface card that transmits or receives data on the basis of an instruction of the processor, wherein the processor receives at least one beamforming signal from an external station, wherein the beamforming signal includes a sector ID for identifying a predetermined sector of the external station, the processor transmits at least one feedback signal to the external station in response to the at least one beamforming signal, and the beamforming signal is received on a first frequency band and the feedback signal is transmitted on a second frequency band.

### Effects of the Invention

According to exemplary embodiments of the present disclosure, it is possible to reduce time required for a sector sweep which is needed for communication using a high-frequency band.

Particularly, according to exemplary embodiments of the present disclosure, there is provided an opportunity to early terminate a sector sweep process if an optimum beam or suitable beam is found during the sector sweep process. Thus, an efficient wireless link configuration method can be provided.

The present disclosure can be used for various communication devices such as stations using wireless LAN and stations using cellular communication.

### BRIEF DESCRIPTION OF THE DRAWINGS

FIG. 1 is a diagram illustrating a wireless LAN system in accordance with an exemplary embodiment;

FIG. 2 is a diagram illustrating a wireless LAN system in accordance with another exemplary embodiment;

FIG. 3 is a block diagram illustrating a configuration of a station in accordance with an exemplary embodiment;

FIG. 4 is a block diagram illustrating a configuration of an access point in accordance with an exemplary embodiment;

FIG. 5 is a diagram illustrating a coverage area depending on a communication frequency band of a station;

FIG. 6 is a diagram illustrating a process of performing a sector sweep by a station;

FIG. 7 is a diagram illustrating an exemplary embodiment of a beacon interval used for conducting wireless communication between stations in accordance with an exemplary embodiment;

FIG. 8 is a diagram illustrating a specific exemplary embodiment of a sector sweep process performed by stations in accordance with an exemplary embodiment;

FIG. 9 is a diagram illustrating a feedback signal transmission method using a second frequency band in accordance with an exemplary embodiment;

FIG. 10 is a diagram illustrating a feedback signal transmission method using a second frequency band in accordance with another exemplary embodiment;

FIG. 11 is a diagram showing DMG capability information in accordance with an exemplary embodiment; and

FIG. 12 to FIG. 14 are diagrams showing frame information of a sector sweep signal and a feedback signal corresponding thereto in accordance with an exemplary embodiment.

### MODE FOR CARRYING OUT THE INVENTION

Hereinafter, embodiments of the present disclosure will be described in detail with reference to the accompanying drawings so that the present disclosure may be readily implemented by those skilled in the art. However, it is to be noted that the present disclosure is not limited to the embodiments but can be embodied in various other ways. In drawings, parts irrelevant to the description are omitted for the simplicity of explanation, and like reference numerals denote like parts through the whole document.

Through the whole document, the term “connected to” or “coupled to” that is used to designate a connection or coupling of one element to another element includes both a case that an element is “directly connected or coupled to” another element and a case that an element is “electronically connected or coupled to” another element via still another element. Further, through the whole document, the term “comprises or includes” and/or “comprising or including” used in the document means that one or more other components, steps, operation and/or existence or addition of elements are not excluded in addition to the described components, steps, operation and/or elements unless context dictates otherwise.

The terms used herein are general terms selected in consideration of functions in the present disclosure and widely used at the present time. However, such terms may vary depending on intentions of those skilled in the art, usual practices, or appearance of new technology. In a specific case, some terms may be selected by the applicant of the present application. In this case, meanings of such terms will be described in corresponding parts of present specification. Therefore, it should be noted that terms used herein are interpreted based on real meanings of the terms and the present specification rather than simple names of the terms.

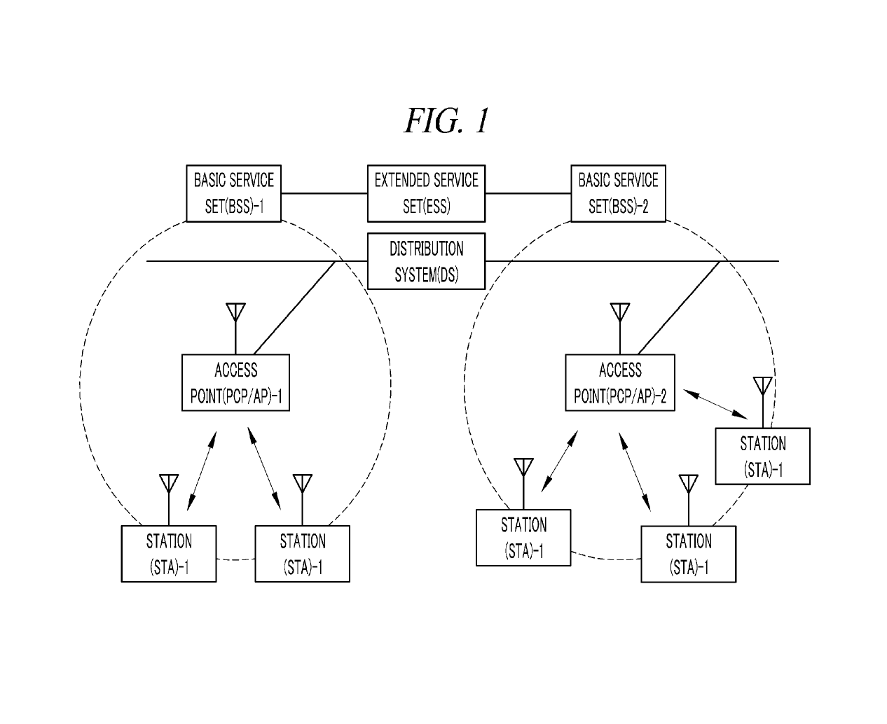

FIG. 1 is a diagram illustrating a wireless LAN system in accordance with an exemplary embodiment. The wireless LAN system includes one or more basic service sets (BSSs), which indicate a group of devices that can be successfully synchronized to communicate with one another. In general, a BSS may be classified into an infrastructure BSS and an independent BSS (IBSS), and FIG. 1 shows an infrastructure BSS.

As illustrated in FIG. 1, the infrastructure BSSs BSS1 and BSS2 include one or more stations STA-1, STA-2, STA-3, STA-4 and STA-5, access points PCP/AP-1 and PCP/AP-2, which are stations providing a distribution service, and a distribution system DS for connecting the multiple access points PCP/AP-1 and PCP/AP-2.

The station (STA) is a device including a medium access control (MAC) following the regulations of the IEEE 802.11 standard and a physical layer interface for a wireless medium, and includes an access point (AP) and a non-access point STA (Non-AP station) in a broad sense. The STA for wireless communication includes a processor and a transceiver, and may further include a user interface unit, a display unit and the like in some exemplary embodiments. The processor is a functional unit designed to produce a frame to be transmitted through a wireless network or process a frame received through the wireless network, and implements various processes for controlling the STA. The transceiver is a unit functionally connected to the processor and designed to transmit and receive a frame for the STA through the wireless network.

The access point (AP) is a functional entity providing connection to the distribution system (DS) via a wireless medium for a STA connected to the AP. It is the principle that in the infrastructure BSS, communication between Non-AP STAs is conducted via an AP. However, direct communication between Non-AP STAs is possible if a direct link is set up. Meanwhile, in the present disclosure, the AP has a concept to include a personal BSS coordination point (PCP), and may have a concept to include any intensive controller, base station (BS), node-B, base transceiver system (BTS), or site controller in a broad sense.

Multiple infrastructures BSSs may be connected to one another through the distribution system (DS). In this case, the multiple BBSs connected to one another through the DS are referred to as an “extended service set (ESS)”. STAs included in the ESS can communicate with one another, and Non-AP STAs within the same ESS may move from one BSS into another BSS while seamlessly communicating with one another.

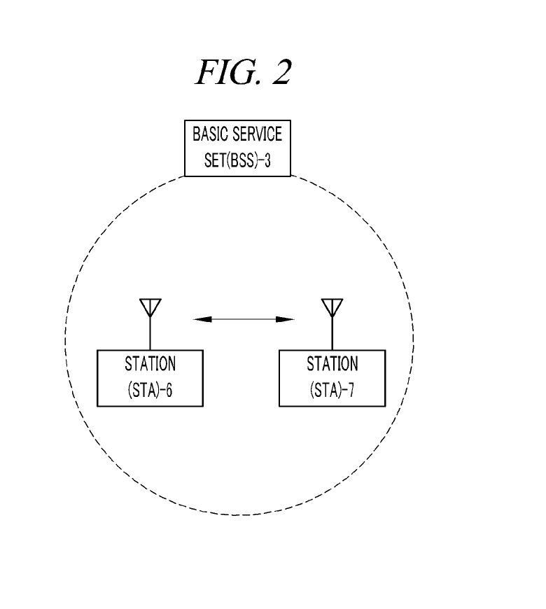

FIG. 2 is a diagram illustrating an independent BSS which is a wireless LAN system in accordance with another exemplary embodiment. The redundant descriptions of the parts in the exemplary embodiment of FIG. 2, which are identical or correspond to those of FIG. 1, will be omitted.

BSS-3 illustrated in FIG. 2 is an independent BSS and does not include an AP. Thus, all stations STA-6 and STA-7 are Non-AP STAs. The independent BSS is not allowed to be connected to the DS, and establishes a self-contained network. In the independent BSS, the stations STA-6 and STA-7 may be directly connected to each other.

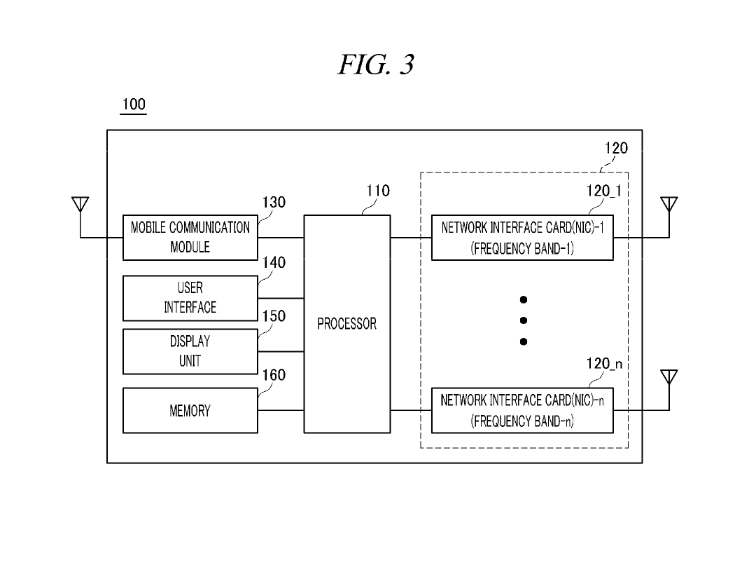

FIG. 3 is a block diagram illustrating a configuration of a STA 100 in accordance with an exemplary embodiment.

As illustrated, a STA 100 in accordance with an exemplary embodiment may include a processor 110, a network interface card (NIC) 120, a mobile communication module 130, a user interface unit 140, a display unit 150, and a memory 160.

First, the NIC 120 is a module for implementing wireless LAN connection and may be provided inside or outside the STA 100. In accordance with an exemplary embodiment, the NIC 120 may include multiple NIC modules 120_1 to 120_n respectively using different frequency bands. For example, the NIC modules 120_1 to 120_n may include NIC modules using different frequency bands of 2.4 GHz, 5 GHz, 60 GHz, and the like. In accordance with an exemplary embodiment, the STA 100 may be provided with at least one NIC module using a frequency band of 6 GHz or more and at least one NIC module using a frequency band of less than 6 GHz. Each of the NIC modules 120_1 to 120_n may independently conduct wireless communication with an AP or an external STA according to a wireless LAN standard of the frequency band supported by the corresponding NIC module 120_1 to 120_n. The NIC 120 may operate only one NIC module 120_1 to 120_n at once or the multiple NIC modules 120_1 to 120_n at the same time depending on performance and demand of the STA 100. Meanwhile, in the block diagram of FIG. 3, the multiple NIC modules 120_1 to 120_n of the STA 100 are illustrated as being separated from one another and a MAC/PHY layer of each of the NIC modules 120_1 to 120_n is independently operated. However, the present disclosure is not limited thereto, and the multiple NIC modules of different frequency bands may be provided as an integrated chip in the STA 100.

Further, the mobile communication module 130 transmits and receives a wireless signal with at least one of a base station, an external device, and a server by using a mobile communication network. Herein, the wireless signal may include data in various forms such as a voice call signal, a video calling call signal, or a text/multimedia message.

Furthermore, the user interface unit 140 includes various input/output means provided in the STA 100. That is, the user interface unit 140 may receive user's input by using the various input means, and the processor 110 may control the STA 100 based on the received user input. Further, the user interface unit 140 may perform output based on an instruction of the processor 110 by using the various output means.

Moreover, the display unit 150 outputs an image on a display screen. The display unit 150 may output various display objects such as contents executed by the processor 110 or user interface based on a control instruction of the processor 110. In addition, the memory 160 stores a control program to be used in the STA 100 and various data relevant thereto. This control program may include an access program necessary to enable the STA 100 to implement an access to an AP or an external STA.

The processor 110 of the present disclosure may execute various instructions or programs, and also process data in the STA 100. Further, the processor 110 may control the above-described units of the STA 100 and data transmission and reception between the units. In accordance with an exemplary embodiment, the processor 110 controls a communication operation of the STA 100 such as sector sweep signal transmission/reception and feedback signal transmission/reception in response thereto.

In accordance with an exemplary embodiment, the processor 110 sequentially transmits a beamforming signal to each of at least one sector and receives a feedback signal from an external station in response to at least one of the transmitted beamforming signals. Herein, the beamforming signal includes a sector ID for identifying a predetermined sector, and the beamforming signal is transmitted on a first frequency band and the feedback signal is received on a second frequency band.

In accordance with another exemplary embodiment, the processor receives at least one beamforming signal from an external station and transmits at least one feedback signal to the external station in response to the at least one beamforming signal. Herein, the beamforming signal includes a sector ID for identifying a predetermined sector of the external station, and the beamforming signal is received on a first frequency band and the feedback signal is transmitted on a second frequency band.

FIG. 3 illustrates a block diagram of the STA 100 in accordance with an exemplary embodiment, and the separately indicated blocks are intended to logically discriminate the elements of the device. Accordingly, the above-described elements of the device may be mounted as one chip or multiple chips depending on a design of the device. Further, in an exemplary embodiment, some of the components of the STA 100, e.g., the mobile communication module 130, the user interface unit 140, and the display unit 150, may be selectively provided in the STA 100.

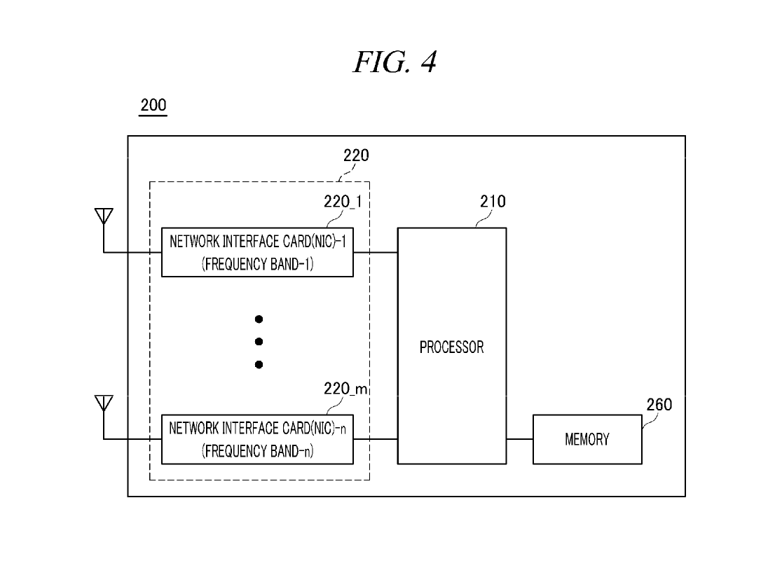

Meanwhile, FIG. 4 is a block diagram illustrating a configuration of an AP 200 in accordance with an exemplary embodiment.

As illustrated, the AP 200 in accordance with an exemplary embodiment may include a processor 210, a network interface card (NIC) 220, and a memory 160. The redundant descriptions of the parts of the AP 200 in the exemplary embodiment of FIG. 4, which are identical or correspond to those of the STA 100 in FIG. 3, will be omitted.

Referring to FIG. 4, the AP 200 in accordance with an exemplary embodiment includes the NIC 220 for operating a BSS in at least one frequency band. As described in the exemplary embodiment illustrated in FIG. 3, the NIC 220 of the AP 200 may also include multiple NIC modules 220_1 to 220_m respectively using different frequency bands. That is, the AP 200 in accordance with an exemplary embodiment may include NIC modules respectively using different frequency bands, e.g., two or more frequency bands of 2.4 GHz, 5 GHz, and 60 GHz. Desirably, the AP 200 may include at least one NIC module using a frequency band of 6 GHz or more and at least one NIC module using a frequency band of less than 6 GHz. Each of the NIC modules 220_1 to 220_m may independently conduct wireless communication with a STA according to a wireless LAN standard of the frequency band supported by the corresponding NIC module 220_1 to 220_m. The NIC 220 may operate only one NIC module 220_1 to 220_m at once or the multiple NIC modules 220_1 to 220_m at the same time depending on performance and demand of the AP 200.

Then, the memory 260 stores a control program to be used in the AP 200 and various data relevant thereto. This control program may include an access program that manages an access of a STA. Further, the processor 210 may control the units of the AP 200 and data transmission and reception between the units.

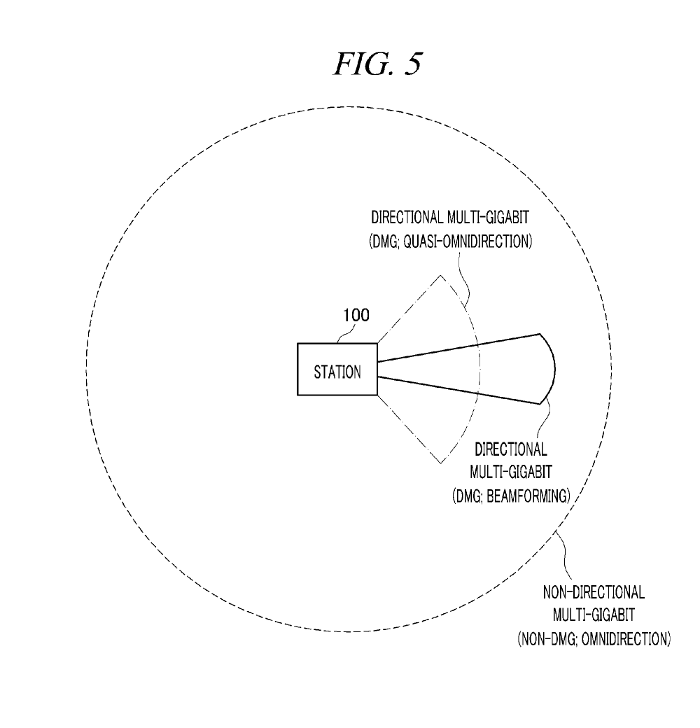

FIG. 5 is a diagram illustrating a coverage area depending on a communication frequency band of the STA 100. Directional multi-gigabit (DMG) areas indicated by a solid line and a broken line in FIG. 5 represent coverage areas using a first frequency band. A non-DMG area indicated by a dotted line represents a coverage area using a second frequency band. In accordance with an exemplary embodiment, the first frequency band may be a band having a higher frequency than the second frequency band. For example, the first frequency band may be a band of 6 GHz or more (directional multi-gigabit band), and the second frequency band may be a band of less than 6 GHz (non-directional multi-gigabit band). Further, in accordance with an exemplary embodiment, the first frequency band may be a 60 GHz band and the second frequency band may be any one of a 2.4 GHz band and a 5 GHz band. However, in an exemplary embodiment of the present disclosure, actual values of the first frequency band and the second frequency band are not limited thereto, and any case where the first frequency band has a higher frequency than the second frequency band may be included. Each of the first frequency band and the second frequency band includes one or more channels.

More specifically, the DMG area indicated by the solid line in FIG. 5 represents a coverage area using a beamforming signal in the first frequency band, and the DMG area indicated by the broken line represents a coverage area using a qausi-omni signal in the first frequency band. The STA 100 may radiate a DMG signal to a specific area by using a directional antenna, and a beamforming signal or a quasi-omni signal may be generated depending on a degree of beamforming of the antenna. Further, the non-DMG area indicated by the dotted line represents a coverage area using an omni signal in the second frequency band. Herein, the STA 100 may radiate a non-DMG signal in an omnidirectional manner by using a non-directional antenna.

As illustrated, it can be seen that even if the same frequency band is used, when a beamforming signal is used, a longer communication distance can be obtained, as compared with a case of using a quasi-omni or omni signal. However, the beamforming signal has a narrow coverage area, and, thus, cannot be transmitted well to an external STA located in a direction different from an intended beam direction. Therefore, in case of using a beamforming signal, a sector sweep process for finding an appropriate beamforming direction depending on a relative location with respect to an external STA as described below is needed.

Meanwhile, it can be seen that in case of using a second frequency band (non-DMG) signal having a low frequency, a longer communication distance than that of a first frequency band (DMG) signal can be obtained. That is, in case of using a second frequency band (non-DMG) signal, the STA 100 can successfully conduct communication with an external STA in a distance in which communication cannot be conducted using the first frequency band (DMG).

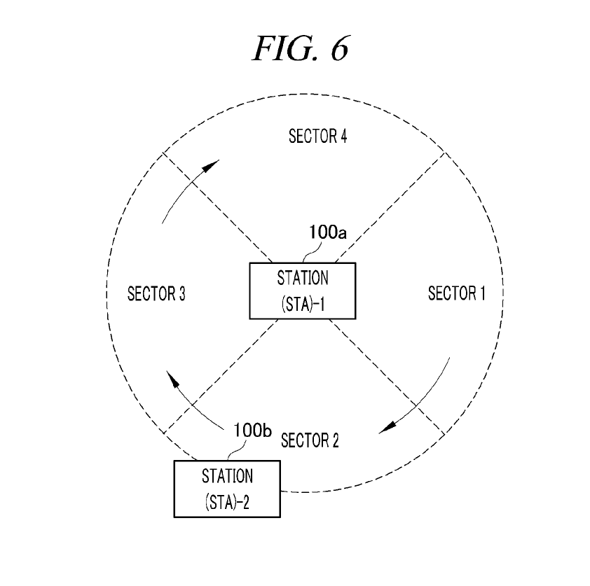

FIG. 6 is a diagram illustrating a process of performing a sector sweep as a previous process by a first station (STA-1) 100a to communicate with a second station (STA-2) 100b using a beamforming signal. In the exemplary embodiment illustrated in FIG. 6, the STA-1 is an initiator that starts a sector sweep and the STA-2 is a responder that makes a response thereto.

The sector sweep refers to a process of checking a TX diversity gain by transmitting a management frame while switching a beam direction or a beam sector. If the STA-1 conducts communication with the STA-2 using a beamforming signal, it is necessary to perform a sector sweep process in order to find an appropriate beamforming direction depending on relative locations of the STA-1 and the STA-2. As illustrated, the STA-1 can sequentially transmit a beamforming signal to multiple sectors set in an omnidirectional or specific directional range. In FIG. 6, the STA-1 may transmit a beamforming signal to a sector 1, a sector 2, a sector 3, and a sector 4 according to a predetermined sequence. However, the four sectors illustrated in FIG. 6 are just examples for illustration. The total number of sectors used in a sector sweep process, the coverage of each sector, and a switching sequence of the sectors may be set by various methods.

When the STA-1 performs the sector sweep, the STA-2 may receive the beamforming signal (sector sweep signal) in an omnidirectional or quasi-omnidirectional manner. In an exemplary embodiment, a quasi-omni section of a STA may include multiple sectors. For example, the STA may include n number of qausi-omni sections for communication, and each quasi-omni section may include m number of sectors. Herein, the STA includes a total of n×m number of sectors in all directions. However, the present disclosure is not limited thereto. Each quasi-omni section may include the same number of sectors or may include a different number of sectors. A distance in which the STA-2 can receive the beamforming signal is longer in the case of receiving the beamforming signal in a quasi-omnidirectional manner than in the case of receiving the beamforming signal in an omnidirectional manner.

In accordance with an exemplary embodiment, if the STA-2 receives the sector sweep signal in a quasi-omnidirectional manner, the sector sweep process of the STA-1 may be repeated in turn among the quasi-omni sections. That is, the STA-2 may receive the sector sweep signal of the STA-1 in a specific quasi-omnidirectional manner for one cycle and, and may receive the sector sweep signal of the STA-1 in each quasi-omni section in the same manner while switching the quasi-omni section. Herein, the STA-1 may repeat the sector sweep cycle as many times as the number of quasi-omni sections. If the STA-1 and the STA-2 equally include n number of quasi-omni sections and m number of sectors (per quasi-omni section), the STA-1 repeats the sector sweep process n number of cycle times to a total of n×m sectors.

As such, if the STA-1 performs the sector sweep, the STA-2 may recognize sector information showing the best received signal quality (best transmission sector information) and transfer the sector information as a feedback signal. The STA-1 may determine an optimum sector to conduct communication with the STA-2 using the beamforming signal (first frequency band signal) based on the feedback signal. Further, the STA-2 may determine an optimum quasi-omni section to receive the beamforming signal (first frequency band signal) of the STA-1.

Meanwhile, if the sector sweep process of the STA-1 is terminated, the STA-1 and the STA-2 exchange transmission/reception functions with each other. Thus, the STA-2 may perform the sector sweep process. That is, the STA-2 as a sector sweep responder may perform a sector sweep and thus send a signal, and the STA-1 as a sector sweep initiator may receive the signal.

In accordance with an exemplary embodiment, the STA-2 may perform the sector sweep using the beamforming signal and the STA-1 may receive the sector sweep signal of the STA-2 in a quasi-omnidirectional manner. In accordance with an exemplary embodiment, the STA-2 may transmit the sector sweep signal only to sectors included in the optimum qausi-omni section determined in the beamforming process of the STA-1. This is because there is a high probability that an optimum sector for the STA-2 to transmit the beamforming signal to the STA-1 is included in the optimum qausi-omni section in which the STA-2 receives the beamforming signal of the STA-1. Further, in accordance with another exemplary embodiment, the STA-1 may receive the sector sweep signal only from a quasi-omni section including an optimum sector determined in a previous sector sweep process of the STA-1. This is because a quasi-omni section including an optimum sector for the STA-1 to transmit the beamforming signal to the STA-2 can become an optimum quasi-omni section for the STA-1 to receive the beamforming signal of the STA-2. Through this process, the STA-2 may rapidly determine an optimum sector for communication with the STA-1.

Meanwhile, in accordance with yet another exemplary embodiment, the STA-2 may transmit a signal repeated in an omnidirectional or quasi-omnidirectional manner and predetermined sectors of the STA-1 may alternately receive the signal of the STA-2. That is, the STA-1 as a sector sweep initiator may perform the sector sweep and receive the signal of the STA-2.

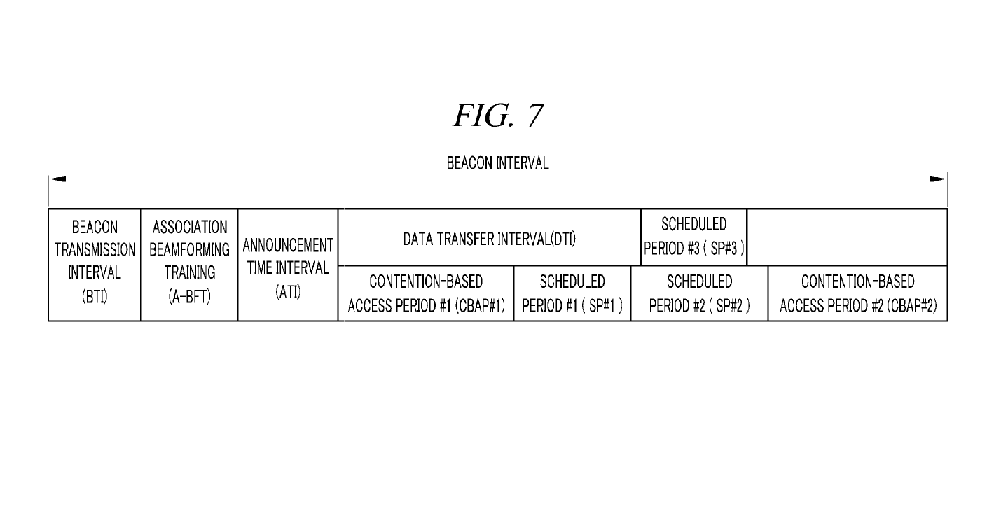

FIG. 7 is a diagram illustrating an exemplary embodiment of a beacon interval used for conducting wireless communication between STAs in accordance with an exemplary embodiment. As illustrated, the beacon interval may include a Beacon Transmission Interval (BTI), an Association BeamForming Training (A-BFT) interval, an Announcement Time Interval (ATI), and a Data Transfer Interval (DTI). A STA and an AP may receive information on a network or conduct communication with a PCP/AP or a neighboring STA during the beacon interval.

First, the BTI refers to an interval in which one or more beacons are transmitted as a directional multi-gigabit (DMG) signal by a PCP/AP. Herein, the PCP/AP transmits the corresponding beacon frame in all directions using a beamforming signal. For example, predetermined sectors of the PCP/AP may alternately transmit the beacon frame in all directions.

The A-BFT interval refers to an interval in which non-AP STAs perform beamforming training with a PCP/AP. During the A-BFT interval, the non-AP STAs may transmit feedback information, which is indicative of receipt of a beacon signal transmitted by the PCP/AP, as a beamforming signal.

The ATI refers to a request-response-based management interval in which a PCP/AP transfers a non-MAC service data unit (non-MSDU) to a non-AP STA to provide a chance of access. The non-AP STA may send the PCP/AP a request to secure a scheduled period of the corresponding STA.

The DTI refers to an interval in which a frame exchange is performed between STAs, and may include a Contention-Based Access Period (CBAP) and a Scheduled Period (SP). In the SP, only a STA allowed to conduct communication within the corresponding BSS may perform beamforming to conduct communication. Further, in the CBAP, there is no STA specially allowed to conduct communication and thus multiple STAs may try to conduct communication in contention with one another.

In accordance with an exemplary embodiment, during the DTI, multiple scheduled periods may coexist in the same time zone. In case of omnidirectional communication, if two or more STAs perform transmission at the same time, a collision may occur. However, in accordance with an exemplary embodiment using a sector or beamforming, even if multiple STAs perform transmission at the same time in a signal transfer direction, it is possible to avoid a collision. Therefore, in the exemplary embodiment illustrated in FIG. 7, SP#2 and SP#3 which are different scheduled periods may be overlapped in the same time zone.

In accordance with an exemplary embodiment, the above-described sector sweep process may be performed in a SP or a CBAP. In order to perform the sector sweep in the SP, a STA that starts a sector sweep makes a request to a PCP/AP and a SP assigned corresponding thereto. In this case, only two STAs that perform the sector sweep process can conduct communication in the SP. Meanwhile, in the CBAP in which a PCP/AP allows access of all STAs which the PCP/AP wants to communicate with, communication can be conducted by competition according to a CSMA/CA method.

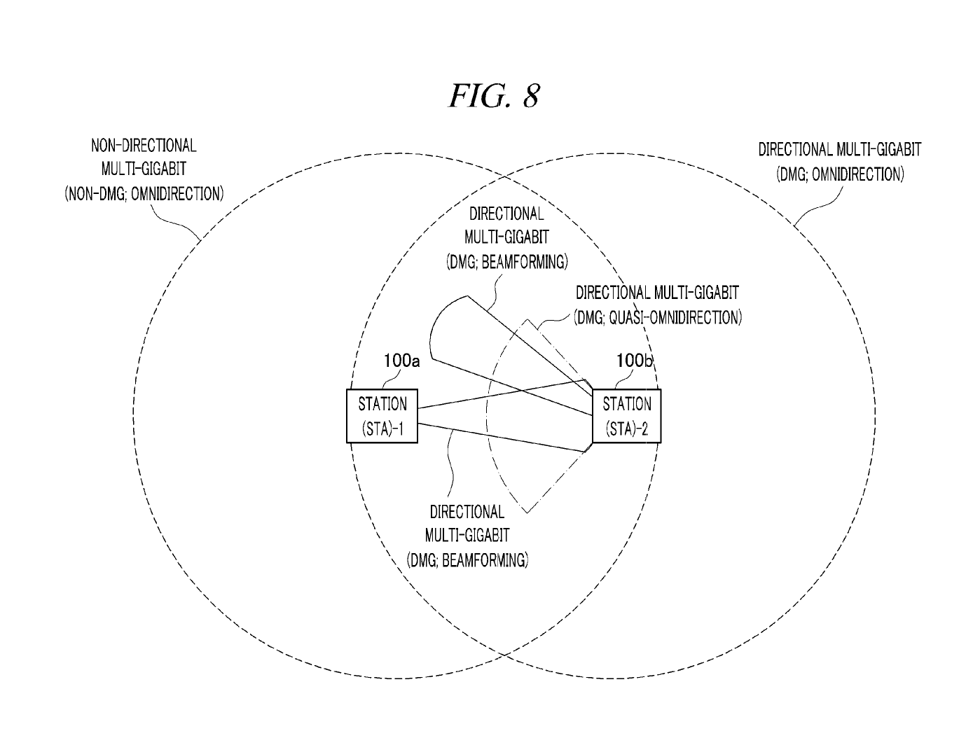

FIG. 8 is a diagram illustrating a specific exemplary embodiment of a sector sweep process performed by the STAs 100a and 100b in accordance with an exemplary embodiment. A DMG area indicated by a solid line in FIG. 8 represents a coverage area using a beamforming signal in the first frequency band, and a DMG area indicated by a broken line represents a coverage area using a quasi-omnidirectional signal in the first frequency band. Further, a non-DMG area indicated by a dotted line represents a coverage area using an omnidirectional signal in the second frequency band. In the exemplary embodiment illustrated in FIG. 8, the STA-1 as a sector sweep initiator transmits a beamforming signal to each sector and the STA-2 as a sector sweep responder receives the sector sweep signal.

As described above with reference to FIG. 6, the STA-1 may transmit a beamforming signal (sector sweep signal) to the first frequency band according to a predetermined sequence of sectors and the STA-2 may receive the sector sweep signal. Herein, the STA-2 may receive the sector sweep signal from the first frequency band in omnidirectional or quasi-omnidirectional manner. While the STA-1 sequentially transmits the sector sweep signal in a sector sweep transmission mode, the STA-2 receives the sector sweep signal in a sector sweep reception mode. Herein, the STA-2 may not receive some or all of sector sweep signals depending on a relative location with respect to the STA-1, and, thus, the STA-2 may synchronize each sector sweep reception section with each sector sweep transmission section using information on a remaining number of times of beamforming sector sweep (CDOWN). For example, the STA-1 and the STA-2 may perform a sector sweep transmission mode and a sector sweep reception mode by decreasing the CDOWN one by one from a predetermined value on a regular cycle until a value of the CDOWN reaches zero (0). Therefore, even if some of sector sweep signals of the STA-1 are not received, the STA-2 does not terminate the sector sweep reception mode until a value of the CDOWN reaches zero (0).

The STA-2 may measure a signal level of the received beamforming signal (sector sweep signal) for each sector. In the present disclosure, the signal level may represent a received signal strength indicator (RSSI) or a signal to noise ratio (SNR). Assuming that transmission of beamforming signals in the same number as the number of sectors of the STA-1 to the STA-2 is referred to as a cycle, the cycle may be performed the same number of times as the number of antennas of the STA-2 and then, the sector sweep process of the STA-1 may be terminated. In accordance with an exemplary embodiment, after the sector sweep process of the STA-1 is terminated, the STA-2 may transmit sector information having the highest signal level as a feedback signal. The STA-1 may determine a sector ID to conduct communication using the first frequency band based on the feedback signal of the STA-2.

Meanwhile, in the sector sweep process, it is necessary to sequentially transmit a beamforming signal to each section or sector in all directions of a STA. Therefore, it may take a considerable time. Further, if the STA-2 receives a sector sweep signal in a quasi-omnidirectional manner, a sector sweep cycle of the STA-1 may need to be repeated the same number of times as the number of quasi-omni sections. Therefore, if the STA-2 finds an optimum sector of the STA-1 for transmission of a beamforming signal to the STA-2, it is efficient to immediately terminate the sector sweep process of the STA-1. In some cases, if the STA-2 finds a beam sector (appropriate beam sector) that ensures an appropriate communication quality for the STA-1 to transmit data to the STA-2 through beamforming, it is possible to maximize the efficiency by immediately terminating the sector sweep process of the STA-1.

However, if the STA-1 and the STA-2 conduct communication using the first frequency band only, even when the STA-2 finds an optimum beam sector or an appropriate beam sector during the sector sweep process of the STA-1, the STA-2 cannot immediately feed back information thereof. This is because the STA-2 needs to receive a beamforming signal (sector sweep signal) of the STA-1 through the first frequency band in the sector sweep reception mode until the sector sweep process of the STA-1 in the sector sweep transmission mode is terminated. Further, this is because before the sector sweep process of the STA-2 is performed, the STA-2 may find an appropriate beam section for transmission of a beamforming signal to the STA-1 but cannot find an optimum beam sector within the corresponding beam section. As illustrated in FIG. 8, even if the STA-2 is set to be in a quasi-omni mode suitable to receive a beamforming signal of the STA-1, the corresponding quasi-omni section does not include multiple sectors. Therefore, an optimum beam sector of the STA-2 cannot yet be found. If the STA-2 transmits a feedback signal to any sector in a quasi-omni section which receives a beamforming signal of the STA-1, the STA-1 may not receive the feedback signal as illustrated in FIG. 8.

In order to solve such a problem, a STA in accordance with an exemplary embodiment may transmit a feedback signal corresponding to a sector sweep signal as a signal of the second frequency band. As illustrated in FIG. 8, it can be seen that in case of using a second frequency band (non-DMG) signal, even if omnidirectional communication is conducted, a coverage area is very wide. In a state where the STA-2 cannot find an optimum sector for transmission of a beamforming signal to the STA-1, the STA-2 may transmit a feedback signal using the second frequency band. Therefore, the STA-1 may receive the feedback signal corresponding to each beamforming signal from the STA-2 in real time while the STA-1 transmits a sector sweep signal to the STA-2.

In accordance with an exemplary embodiment, a wireless link configuration method of a station includes: sequentially transmitting a beamforming signal to each of at least one sector; and receiving a feedback signal corresponding to at least one of the transmitted beamforming signals from an external station. Herein, the beamforming signal includes a sector ID for identifying a predetermined sector, and the beamforming signal is transmitted on a first frequency band and the feedback signal is received on a second frequency band. Further, the feedback signal may include a sector ID for identifying a predetermined sector and a signal level of a beamforming signal transmitted to the sector corresponding to the sector ID.

In accordance with another exemplary embodiment, a wireless link configuration method of a station includes: receiving at least one beamforming signal from an external station; and transmitting at least one feedback signal to the external station in response to the at least one beamforming signal. Herein, the beamforming signal includes a sector ID for identifying a predetermined sector of the external station, and the beamforming signal is received on a first frequency band and the feedback signal is transmitted on a second frequency band. Further, the feedback signal may include a sector ID for identifying a predetermined sector of the external station and a signal level of a beamforming signal received from the sector corresponding to the sector ID.

Hereinafter, the wireless link configuration method of a station in accordance with an exemplary embodiment will be described in more detail with reference to the accompanying drawings.

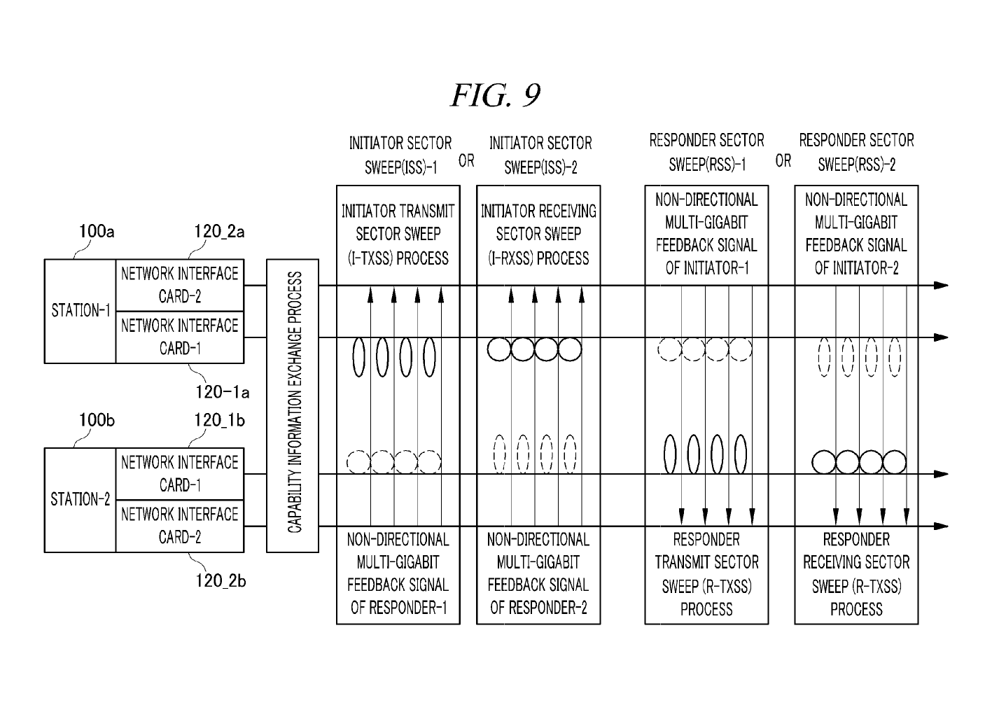

FIG. 9 is a diagram illustrating a feedback signal transmission method using a second frequency band in accordance with an exemplary embodiment. In the processes I-TXSS, I-RXSS, R-TXSS, and R-RXSS illustrated in FIG. 9, an ellipse represents signal transmission/reception using beamforming and a circle represents omnidirectional or quasi-omnidirectional signal transmission/reception. Further, a circle and an ellipse indicated by a solid line represent signal transmission, and a circle and an ellipse indicated by a dotted line represent signal reception.

In the exemplary embodiment illustrated in FIG. 9, the STA-1 100a is a sector sweep initiator and the STA-2 100b is a sector sweep responder. As illustrated, the STA-1 100a in accordance with an exemplary embodiment may include multiple NIC modules, i.e., a NIC-1 120_1a using the first frequency band and a NIC-2 120_2a using the second frequency band. Likewise, the STA-2 100b may include a NIC-1 120_1b using the first frequency band and a NIC-2 120_2b using the second frequency band. Each of these network interface cards may independently process a signal of a predetermined frequency band. In accordance with an exemplary embodiment, the first frequency band may have a higher frequency than the second frequency band. For example, it may be assumed that the first frequency band is a band of 6 GHz or more (directional multi-gigabit band), and the second frequency band is a band of less than 6 GHz (non-directional multi-gigabit band).

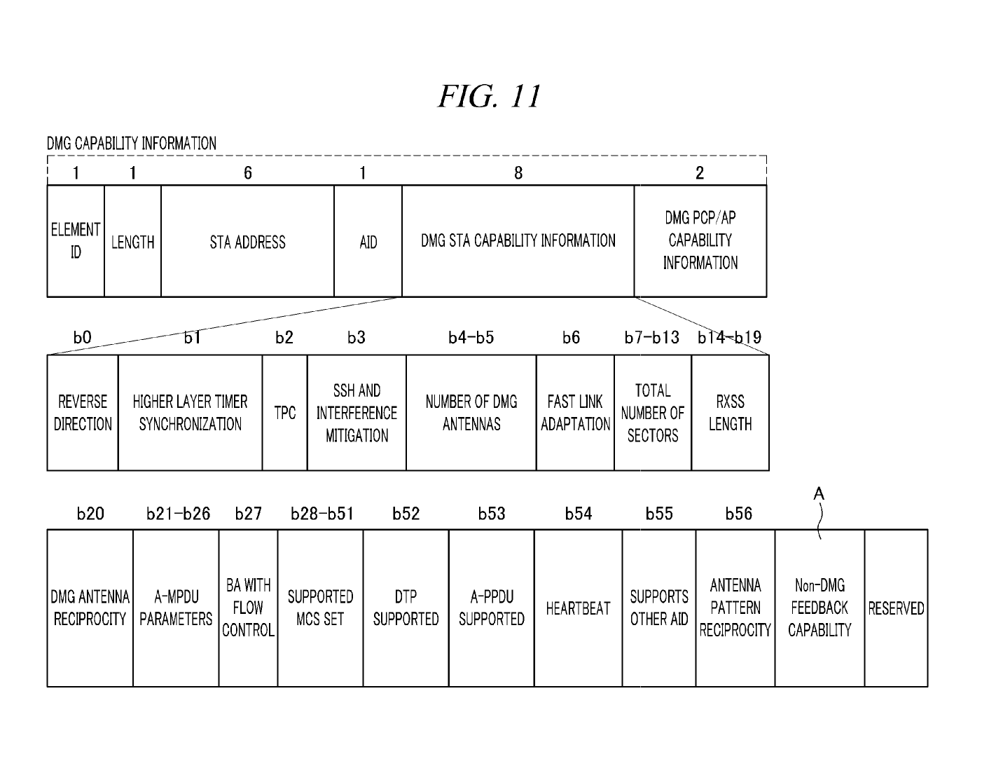

Firstly, the STA-1 and the STA-2 may perform a capability exchange process as a previous process for performing a sector sweep. During the capability exchange process, the STA-1 and the STA-2 exchange DMG capability information with each other. Details of the DMG capability information will be described later with reference to FIG. 11. In accordance with an exemplary embodiment, the STA-1 and the STA-2 may exchange each DMG capability information using the first frequency band. Further, in accordance with an exemplary embodiment, information indicative of whether or not each of the STA-1 and the STA-2 can transmit and receive a signal on the second frequency band may be included.

Then, the STA-1 and the STA-2 perform an initiator sector sweep (ISS) process. In accordance with an exemplary embodiment, if the ISS process is performed, at least one of an initiator transmit sector sweep (I-TXSS) and an initiator receive sector sweep (I-RXSS) may be performed.

As illustrated, if the STA-1 and the STA-2 performs the I-TXSS process, the STA-1 performs the initiator transmit sector sweep (I-TXSS) using a beamforming signal and the STA-2 receives the sector sweep signal in an omnidirectional or quasi-omnidirectional manner. The STA-1 may sequentially transmit a beamforming signal to each of at least one sector, and the STA-2 may receive at least one beamforming signal from the STA-1. If the STA-2 receives the sector sweep signal using a single antenna in an omnidirectional manner, the STA-1 may transmit the sector sweep signal on a cycle equivalent to the total number of sectors included therein. The sector sweep signal transmitted by the STA-1 may include information such as a sector ID of the corresponding beamforming signal and an antenna ID. In an exemplary embodiment, the sector ID includes a combination of the sector ID and the antenna ID in a broad sense. The STA-2 measures a signal level of the received beamforming signal. In the present disclosure, the signal level may represent a received signal strength indicator (RSSI) or a signal to noise ratio (SNR). In accordance with the exemplary embodiment illustrated in FIG. 9, the STA-2 may generate a feedback signal corresponding to each beamforming signal received using the first frequency band and transmit the feedback signal using the second frequency band. The feedback signal may be an omnidirectional signal. Further, the feedback signal transmitted by the STA-2 may include information such as a sector ID of the corresponding beamforming signal received by the STA-2, an antenna ID, and a signal level. Likewise, in an exemplary embodiment, the sector ID included in the feedback signal includes a combination of the sector ID and the antenna ID.

The STA-1 may receive the feedback signal of the STA-2 in real time while a sector sweep is performed or a beamforming signal is transmitted to each of at least one sector. FIG. 9 illustrates that a feedback signal corresponding to each beamforming signal is immediately received by the STA-1. However, there may be a delay between reception of each beamforming signal and transfer of a feedback signal corresponding thereto.

Such a delay may occur since the STA-2 and other STAs operating in the second frequency band perform contention-based medium access to wireless resources in the second frequency band. If transmission of the feedback signal is delayed, the STA-2 may store feedback information to be transmitted through the feedback signal. Then, the STA-2 succeeds in medium access, the STA-2 may transmit at least one information (a sector ID, a signal level, and the like), which is kept when a feedback signal is first transmitted, to the STA-1 at once. Otherwise, if the STA-2 additionally receives a beamforming signal while transmission of the feedback signal is delayed, the STA-2 may discard feedback information corresponding to a previously received beamforming signal and try to generate and transmit new feedback information.

In an exemplary embodiment, a priority of medium access for transmission of a beamforming signal may be improved in order to suppress a delay of a feedback signal as described above. To this end, at the time of medium access for transmission of a beamforming signal, a specific IFS may be applied. In an exemplary embodiment, the STA-2 may try to perform medium access using a short IFS (SIFS) and/or a PCF IFS (PIFS) for transmission of a feedback signal. In this case, there is a high probability that the STA-2 performs medium access prior to medium access by other STAs for transmission of general data. Therefore, it is possible to reduce the likelihood of occurrence of a feedback signal delay caused by collisions with the other STAs.

The STA-1 may determine whether or not to early terminate transmission of a beamforming signal before transmitting a beamforming signal to all sectors on the basis of the received feedback signal, and may early terminate the initiator transmit sector sweep (I-TXSS) according to a result of the determination. That is, if information included in the received feedback signal satisfies a predetermined condition, the STA-1 may terminate a sector sweep to all sectors even before the sector sweep is completed. Further, if the STA-1 determines to early terminate transmission of a beamforming signal before transmitting a beamforming signal to all sectors, the STA-1 may determine a sector ID for conducting communication with the STA-2 using the first frequency band on the basis of the received feedback signal.

In accordance with an exemplary embodiment, the STA-1 may determine whether or not to early terminate the I-TXSS on the basis of a result of a comparison between a signal level included in a received feedback signal and a predetermined early termination level. If the signal level included in the received feedback signal is equal to or higher than the predetermined early termination level, the STA-1 may terminate the I-TXSS. Meanwhile, the STA-1 may use the result of the comparison between the signal level included in the received feedback signal and the predetermined early termination level for the STA-1 in order to determine a sector for conducting communication with the STA-2 using the first frequency band. Herein, the STA-1 may determine a sector ID included in the feedback signal having the signal level equal to or higher than the predetermined early termination level as a sector ID for conducting communication with the STA-2 using the first frequency band. In addition, the predetermined early termination level for the STA-1 may be the same as a predetermined early termination level for the STA-2 or may vary depending on an environment and needs of each station.

In accordance with another exemplary embodiment, the STA-1 may determine whether or not to early terminate the I-TXSS on the basis of a result of a comparison between a signal level included in any feedback signal and a signal level included in a feedback signal received prior to the any feedback signal. That is, if the signal level included in the any feedback signal is higher than the signal level included in the feedback signal received prior to the any feedback signal, the STA-1 may keep performing the I-TXSS, and if the signal level included in the any feedback signal is lower than the signal level included in the feedback signal received prior to the any feedback signal, the STA-1 may terminate the I-TXSS. Meanwhile, the STA-1 may use the result of the comparison between the signal level included in the any feedback signal and the signal level included in the feedback signal received prior to the any feedback signal in order to determine a sector for conducting communication with the STA-2 using the first frequency band. For example, if the signal level included in the any feedback signal is higher than the signal level included in the feedback signal received prior to the any feedback signal, the STA-1 may determine a sector ID included in the any feedback signal as a new reference sector ID. If the signal level included in the any feedback signal is lower than the signal level included in the feedback signal received prior to the any feedback signal, the STA-1 may determine a currently set reference sector ID as a sector ID for conducting communication with the STA-2 using the first frequency band.

In accordance with yet another exemplary embodiment, the STA-1 may determine whether or not to early terminate the I-TXSS on the basis of a result of a comparison between a signal level included in any feedback signal and a signal level included in a feedback signal received prior to the any feedback signal and a result of a comparison between a signal level included in any feedback signal and a predetermined early termination level for the STA-1.

In accordance with still another exemplary embodiment, the STA-1 may set an initial value of a reference signal level to zero (0) and an initial value of a reference sector ID to N/A and terminate the I-TXSS on the basis of a result of a comparison between a signal level included in a received feedback signal and the reference signal level. If the signal level included in the received feedback signal is higher than the reference signal level, the reference signal level may be updated with the signal level included in the received feedback signal and the reference sector ID may be updated with a sector ID included in the feedback signal. If the signal level included in the received feedback signal is lower than the reference signal level, the STA-1 may terminate the I-TXSS. Herein, the STA-1 may determine a currently set reference sector ID as a sector ID for conducting communication with the STA-2 using the first frequency band.

In accordance with still another exemplary embodiment, the STA-1 may terminate the I-TXSS on the basis of a moving average value of a signal level included in a received feedback signal. That is, the STA-1 may compare an average value of signal level information included in a predetermined number of previous feedback signals and signal level information included in a currently received feedback signal. If the signal level information included in the received feedback signal is higher than the average value, the STA-1 may keep performing the I-TXSS and update the average value. If the signal level information included in the received feedback signal is lower than the average value, the STA-1 may terminate the I-TXSS. If the I-TXSS is terminated, the STA-1 may select a feedback signal having the highest signal level among the previous feedback signals used for the comparison and determine a sector ID included in the feedback signal as a sector ID for conducting communication with the STA-2 using the first frequency band.

In accordance with still another exemplary embodiment, the feedback signal may include information indicative of early termination of transmission of a beamforming signal of the STA-1. The STA-2 may also perform a separate determination process in the same manner as the above-described determination process of the STA-1. Herein, an early termination level used for the determination process of the STA-2 may be the same as the early termination level for the STA-1 or may vary depending on an environment and needs of each station. The STA-1 may terminate the I-TXSS on the basis of the information indicative of early termination included in the feedback signal.

As described above, the STA-1 in accordance with the exemplary embodiments may early terminate the initiator transmit sector sweep (I-TXSS) using various methods. Further, the STA-1 may determine an optimum beam sector or an appropriate beam sector for conducting communication with the STA-2 using the first frequency band.

The STA-1 may transmit information indicative of early termination of transmission of a beamforming signal or information indicative of early termination of a sector sweep to the STA-2 before transmitting a beamforming signal to all sectors in order to early terminate the initiator transmit sector sweep (I-TXSS). In an exemplary embodiment, the STA-1 may set information on a remaining number of times of beamforming sector sweep (CDOWN) to zero (0) and retransmit the set information on a remaining number of times of beamforming sector sweep through a beamforming signal of a sector corresponding to a determined sector ID. However, a method of setting the CDOWN value is not limited thereto. The STA-1 may set the CDOWN value to a predetermined value indicative of early termination of transmission of a beamforming signal or early termination of a sector sweep and transmit the set CDOWN value. For example, the predetermined value may be the highest value to be assigned to the CDOWN. The STA-2 having received a retransmitted beamforming signal may confirm that the CDOWN value is zero (0) (or the predetermined value) and also terminate the I-TXSS process. In accordance with an exemplary embodiment, the STA-2 may transmit a feedback signal indicative of receipt of the retransmitted beamforming signal to the STA-1. The STA-1 may terminate the I-TXSS after successfully receiving the feedback signal.

Meanwhile, in accordance with an exemplary embodiment, the STA-2 may include multiple antennas, and a sector sweep signal of the STA-1 may be received by multiple quasi-omni sections through the antennas. Herein, the above-described initiator transmit sector sweep (I-TXSS) may be repeated multiple cycles. The number of repeated cycles of the I-TXSS may be determined depending on the number of antennas of the STA-2, i.e., the number of quasi-omni sections. Hereinafter, there will be described an exemplary embodiment in which the I-TXSS is performed multiple cycles. However, the redundant descriptions of parts identical or corresponding to those of the above-described exemplary embodiment in which the I-TXSS is performed one cycle will be omitted.

If an I-TXSS is performed multiple cycles in accordance with an exemplary embodiment, the STA-1 may terminate the I-TXSS on the basis of a feedback signal of the STA-2. That is, if information included in the received feedback signal satisfies a predetermined condition according to the above-described exemplary embodiments, the STA-1 may terminate the corresponding sector sweep cycle and determine a representative sector ID in the corresponding cycle. The STA-1 may determine at least one representative sector ID in each I-TXSS cycle and select a sector ID having the optimum performance (e.g., a sector having the highest signal level included the corresponding feedback signal) among the determined representative sector IDs as a sector for conducting communication with the STA-2 using the first frequency band.

The STA-1 may transmit information indicative of early termination of a sector sweep cycle to the STA-2 in order to early terminate the initiator transmit sector sweep (I-TXSS) cycle. That is, the STA-1 may set information on a remaining number of times of beamforming sector sweep (CDOWN) to a predetermined value and retransmit the set information on a remaining number of times of beamforming sector sweep through a beamforming signal of a sector corresponding to a determined sector ID. The STA-2 having received a retransmitted beamforming signal may terminate the I-TXSS cycle. In accordance with an exemplary embodiment, the STA-2 may transmit a feedback signal indicative of receipt of the retransmitted beamforming signal to the STA-1. The STA-1 may terminate the I-TXSS cycle after successfully receiving the feedback signal.

As described above, if the I-TXSS cycle is terminated, the STA-1 and the STA-2 may restart the I-TXSS cycle for another quasi-omni section of the STA-2 by the same method. The I-TXSS cycle may be repeated the same number of times as the number of quasi-omni sections of the STA-2. In accordance with an exemplary embodiment, the STA-1 may transmit a beamforming signal only to some sectors rather than to all sectors of the corresponding STA in the I-TXSS cycle except the first I-TXSS cycle. For example, the STA-1 may transmit a sector sweep signal only to sectors of a quasi-omni section including a representative beamforming signal determined in a previous cycle. This is because there is a high probability that an optimum sector determined in a previous cycle or its neighboring sector also becomes an optimum sector in a subsequent cycle. For a reduced I-TXSS cycle, the STA-1 and the STA-2 may use an adjusted CDOWN value.

Then, if the STA-1 and the STA-2 perform the I-RXSS process, the STA-1 repeatedly transmits a sector sweep signal in a quasi-omnidirectional manner and each sector of the STA-2 receives the repeated sector sweep signal of the STA-1. Herein, the STA-1 may determine the number of times of transmission of the repeated sector sweep signal on the basis of a RXSS length field value of the STA-2 included in DMG capability information. For example, if the RXSS length field value of the STA-2 is not zero (0), the I-RXSS process may be automatically started after the I-TXSS process is terminated, and if the RXSS length field value is zero (0), the I-RXSS process may be skipped.

As described in the exemplary embodiment of the I-TXSS, the STA-2 may generate a feedback signal corresponding to each of received sector sweep signals and transmit the feedback signal using the second frequency band. The feedback signal transmitted by the STA-2 may include signal level information of the sector sweep signals received by the STA-2. The STA-1 may terminate the sector sweep (I-RXSS) on the basis of the received feedback signal. That is, if information included in the received feedback signal satisfies a predetermined condition, the STA-1 may terminate a sector sweep even before the sector sweep is completed. Details thereof are the same as described above in the exemplary embodiment for the I-TXSS process.

The STA-1 may transmit information indicative of early termination of a sector sweep to the STA-2 in order to early terminate the initiator receive sector sweep (I-RXSS). In accordance with an exemplary embodiment, the STA-1 may set information on a remaining number of times of beamforming sector sweep (CDOWN) to zero (0) and retransmit the set information using the second frequency band. The STA-2 having received the information indicative of early termination may confirm that the CDOWN value is zero (0) (or a predetermined value) and also terminate a RSS. In accordance with an exemplary embodiment, the STA-2 may transmit a feedback signal indicative of receipt of the retransmitted beamforming signal to the STA-1. The STA-1 may terminate the I-RXSS after successfully receiving the feedback signal.

If one cycle or multiple cycles of the ISS process is terminated as such, the STA-1 and the STA-2 perform a responder sector sweep (RSS) process. Hereinafter, the RSS process in accordance with an exemplary embodiment will be described. However, the redundant descriptions of parts identical or corresponding to those of the above-described exemplary embodiment of the ISS process will be omitted. In accordance with an exemplary embodiment, the RSS may be performed by any one of a responder transmit sector sweep (R-TXSS) and a responder receive sector sweep (R-RXSS).

Firstly, the R-TXSS may be performed only when the STA-2 as a responder includes multiple sectors or transmits a beamforming signal. In the R-TXSS, the STA-2 transmits a beamforming signal to each sector and the STA-1 receives at least one beamforming signal (sector sweep signal) in an omnidirectional or quasi-omnidirectional manner. If the STA-1 includes a single antenna, the STA-1 may receive the sector sweep signal in an omnidirectional manner. If the STA-1 includes multiple antennas, the STA-1 may receive the sector sweep signal using each of the antennas in a quasi-omnidirectional manner. In accordance with an exemplary embodiment, the STA-1 may receive the sector sweep signal of the STA-2 only by a quasi-omni section including a sector determined in the ISS process. This is because an antenna showing an optimum beamforming transmission performance with respect to the STA-2 may show an optimum performance when receiving a beamforming signal of the STA-2.

Meanwhile, in accordance with an exemplary embodiment, if the STA-2 includes multiple antennas, a DMG antenna reciprocity field of the STA-2 included in DMG capability information can be seen. If the DMG Antenna Reciprocity is set to 1, the STA-2 may transmit a sector sweep signal only to sectors in a quasi-omni section showing an optimum reception performance in a previous ISS process. This is because an antenna showing an optimum beamforming reception performance with respect to the STA-1 may show an optimum performance when transmitting a beamforming signal of the STA-2. However, if the DMG Antenna Reciprocity is set to zero (0), the STA-2 may transmit a sector sweep signal to sectors of all quasi-omni sections.

The sector sweep signal transmitted by the STA-2 may include information such as a sector ID of the corresponding beamforming signal and an antenna ID. That is, each sector ID is a value for identifying a predetermined sector of the STA-2. The STA-1 may measure a signal level of the received beamforming signal. As described above, in the present disclosure, the signal level may represent a received signal strength indicator (RSSI) or a signal to noise ratio (SNR). In accordance with the exemplary embodiment illustrated in FIG. 9, the STA-1 may generate a feedback signal in response to each of beamforming signals received using the first frequency band and transmit the feedback signal using the second frequency band. The feedback signal transmitted by the STA-1 may include information such as a sector ID of the corresponding beamforming signal received by the STA-1, an antenna ID, and a signal level.

The STA-2 may terminate the sector sweep (R-TXSS) on the basis of the feedback signal received from the STA-1. That is, if information included in the received feedback signal satisfies a predetermined condition, the STA-2 may terminate a sector sweep to all sectors even before the sector sweep is completed. Further, the STA-2 may determine a sector ID for conducting communication with the STA-1 using the first frequency band on the basis of the feedback signal. Details thereof are the same as described above in the exemplary embodiment for the ISS process.

The STA-2 may transmit information indicative of early termination of a sector sweep to the STA-1 in order to early terminate the responder sector sweep (RSS). In accordance with an exemplary embodiment, the STA-2 may set information on a remaining number of times of beamforming sector sweep (CDOWN) to zero (0) and retransmit a beamforming signal including the set information to the determined sector. However, a method of setting the CDOWN value is not limited thereto. As described above, the STA-1 may set the CDOWN value to a predetermined value indicative of early termination of a sector sweep and transmit the set CDOWN value. The STA-1 having received a retransmitted beamforming signal may confirm that the CDOWN value is zero (0) (or the predetermined value) and also terminate the RSS process. In accordance with an exemplary embodiment, the STA-1 may transmit a feedback signal indicative of receipt of the retransmitted beamforming signal to the STA-2. The STA-2 may terminate the RSS after successfully receiving the feedback signal.

Then, if the STA-1 and the STA-2 perform the R-RXSS process, the STA-2 repeatedly transmits a sector sweep signal in a quasi-omnidirectional manner and each sector of the STA-1 receives the repeated sector sweep signal of the STA-2. Herein, the STA-2 may determine the number of times of transmission of the repeated sector sweep signal on the basis of a RXSS length field value of the STA-1 included in DMG capability information. For example, if the RXSS length field value of the STA-1 is not zero (0), the R-RXSS process may be automatically started after the R-TXSS process is terminated, and if the RXSS length field value is zero (0), the R-RXSS process may be skipped.

As described in the exemplary embodiments of the ISS and the R-TXSS, the STA-1 may generate a feedback signal corresponding to each of received sector sweep signals and transmit the feedback signal using the second frequency band. The feedback signal transmitted by the STA-1 may include signal level information of the sector sweep signals received by the STA-1. The STA-2 may terminate the sector sweep (R-RXSS) on the basis of the received feedback signal. That is, if information included in the received feedback signal satisfies a predetermined condition, the STA-2 may terminate a sector sweep even before the sector sweep is completed. Details thereof are the same as described above in the exemplary embodiment for the ISS process.

The STA-2 may transmit information indicative of early termination of a sector sweep to the STA-1 in order to early terminate the responder sector sweep (RSS). In accordance with an exemplary embodiment, the STA-2 may set information on a remaining number of times of beamforming sector sweep (CDOWN) to zero (0) and retransmit the set information using the second frequency band. The STA-1 having received the information indicative of early termination may confirm that the CDOWN value is zero (0) (or a predetermined value) and also terminate the RSS. In accordance with an exemplary embodiment, the STA-1 may transmit a feedback signal indicative of receipt of the retransmitted beamforming signal to the STA-2. The STA-2 may terminate the RSS after successfully receiving the feedback signal.

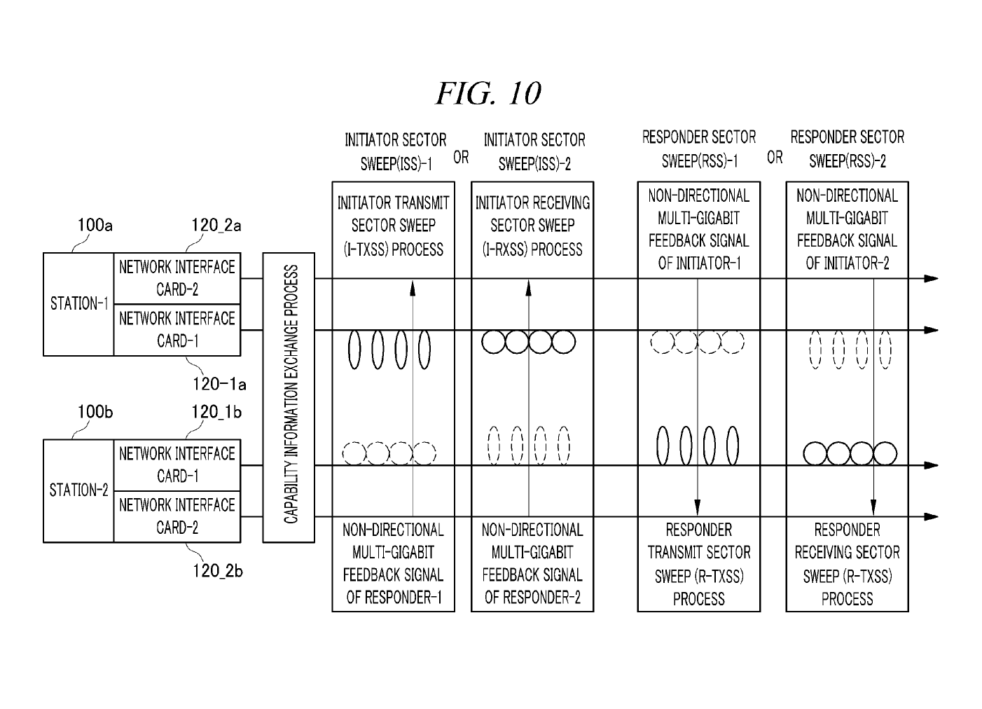

FIG. 10 is a diagram illustrating a feedback signal transmission method using a second frequency band in accordance with another exemplary embodiment. The redundant descriptions of the parts in the exemplary embodiment of FIG. 10, which are identical or correspond to those of FIG. 9, will be omitted.

In accordance with the exemplary embodiment illustrated in FIG. 10, in the initiator transmit sector sweep (I-TXSS) process, the STA-1 receives a feedback signal corresponding to at least one beamforming signal transmitted from the STA-2. That is, the STA-2 transmits at least one feedback signal to the STA-1 in response to at least one beamforming signal.

In accordance with the exemplary embodiment illustrated in FIG. 10, the STA of the present disclosure may determine whether or not to generate a feedback signal on the basis of a received beamforming signal.

In accordance with an exemplary embodiment, a STA may determine whether or not to generate a feedback signal on the basis of a result of a comparison between a signal level of a beamforming signal received by the STA in a sector sweep process and a predetermined early termination level. As illustrated, the STA-2 transmits a feedback signal using the second frequency band in response to only a beamforming signal having a signal level equal to or higher than the predetermined early termination level among the beamforming signals of the STA-1 received in the initiator transmit sector sweep (I-TXSS) process. In the I-TXSS process, the STA-2 may transmit only one feedback signal corresponding to an optimum beamforming signal or may transmit one or more feedback signals corresponding to beamforming signals having a signal level equal to or higher than the predetermined early termination level.

In accordance with another exemplary embodiment, a STA may determine whether or not to generate a feedback signal on the basis of a result of a comparison between a signal level included in any beamforming signal received by the STA in a sector sweep process and a signal level included in a feedback signal received prior to the any feedback signal.

If the STA-2 transmits only one feedback signal corresponding to an optimum beamforming signal, the feedback signal may include information indicative of early termination of the initiator transmit sector sweep (I-TXSS). That is, the STA-2 may transmit ACK indicative of early termination of the initiator transmit sector sweep (I-TXSS) and the STA-1 may terminate the initiator transmit sector sweep (I-TXSS) on the basis of the ACK. If the STA-2 transmits multiple feedback signals, the STA-1 may determine to early terminate the initiator transmit sector sweep (I-TXSS) on the basis of the various methods described in the exemplary embodiment illustrated in FIG. 9.

Likewise, in the responder transmit sector sweep (R-TXSS) process, the STA-1 may transmit a feedback signal using the second frequency band in response to only a beamforming signal having a signal level equal to or higher than the predetermined early termination level among the received beamforming signals of the STA-2. Details of the RSS process are the same as described above in the exemplary embodiment for the ISS process.

In accordance with an exemplary embodiment, early termination level information referred to by the STA-1 and the STA-2 may be a predetermined value. Further, in accordance with another exemplary embodiment, the STA-1 and the STA-2 may exchange the early termination level information with each other through the capability exchange process. In accordance with yet another exemplary embodiment, the early termination level information may be transmitted as being included in each sector sweep signal in the initiator sector sweep (ISS) process and the responder sector sweep (RSS) process.

FIG. 11 is a diagram showing DMG capability information in accordance with an exemplary embodiment.

In the present disclosure, the DMG capability information includes an identifier (ID) of the corresponding STA and multiple fields for informing DMG capability supported by the corresponding STA. In the present disclosure, the DMG capability information may include an element field, a length field, a STA address field including a MAC address of the STA, an association identifier field (AID) including an association identifier assigned to the STA by an access point, a directional multi-gigabit station capability information field (DMG STA Capability Information), and a directional multi-gigabit access point capability information field (DMG PCP/AP Capability Information). In an exemplary embodiment, the DMG capability information may be included in a probe request/probe response frame, an association request/association response frame, and a reassociation request/reassociation response frame. Further, the DMG capability information may also be included in a DMG beacon and information request/information response frame.

As illustrated, the DMG capability information may include various fields. The DMG capability information includes a reverse direction field, a higher layer timer synchronization field, a TPC field, a spatial sharing and interference mitigation field (SPSH and Interference Mitigation), a DMG antenna number field (Number of DMG Antennas), a fast link adaptation field, a total sector number field (Total number of Sectors), a RXSS length field, a DMG antenna reciprocity field, an all message protocol data unit parameter field (A-MPDU Parameters), a block-ack with flow control field (BA with flow control), a supported modulation and coding scheme set field (Supported MCS Set), a supported dynamic tone pairing field (DTP Supported), a supported all presentation protocol data unit field (A-PPDU Supported), an other-support field (Supports other_AID), a heartbeat field, an antenna pattern reciprocity field, and a non-directional multi-gigabit feedback capability field (Non-DMG Feedback Capability) (A).

Firstly, the reverse direction field is a field indicative of whether the corresponding station supports a reverse direction protocol. The higher layer timer synchronization field is a field indicative of whether the corresponding station supports higher layer timer synchronization. The TPC field is a field indicative of whether the corresponding station supports a TPC protocol. The spatial sharing and interference mitigation field is a field indicative of whether the corresponding station can perform functions of spatial sharing (SPSH) and interference mitigation and a parameter dot11RadioMeasurement is in an active state. The DMG antenna number field indicates the number of DMG antennas included in the corresponding station, and the number of quasi-omni sections may be determined on the basis of the above-described information. The fast link adaptation field is a field indicative of whether the corresponding station supports a fast link adaptation process. Further, the total sector number field indicates the total number of separate sectors included in the corresponding station. When a beamforming signal is transmitted in a sector sweep process, the STA may repeatedly transmit the beamforming signal as many times as the total number of sectors. Then, the RXSS length field may indicate the number of sectors of a receiving STA in a sector sweep process. The DMG antenna reciprocity field indicates whether an optimum DMG transmitting antenna is identical to an optimum DMG receiving antenna. That is, if the DMG antenna reciprocity field is set to 1, the optimum DMG transmitting antenna of the corresponding STA is identical to the optimum DMG receiving antenna, and if the DMG antenna reciprocity field is set to zero (0), the optimum DMG transmitting antenna of the corresponding STA may not be identical to the optimum DMG receiving antenna. The all message protocol data unit parameter field may include a maximum A-MPDU length index subfield indicative of a maximum length of an A-MPDU which can be received by the corresponding station, and a minimum MPDU start spacing subfield that determines a minimum time (measured by a PHY-SAP) between starts of adjacent MPDUs within the A-MPDU which can be received by the corresponding station. The block-ack with flow control field is a field indicative of whether the corresponding station supports a flow control together with black-ack. The supported modulation and coding scheme set field indicates a modulation and a coding scheme supported by a DMG station, and the modulation and the coding scheme are identified by a MCS index and interpretation of the MCS index may be PHY-dependent. The supported dynamic tone pairing field (DTP Supported) indicates whether the corresponding station supports dynamic tone pairing. The supported all presentation protocol data unit field (A-PPDU Supported) indicates whether an A-PPDU is supported. The other-support field (Supports other_AID) indicates setting of an antenna weight vector (AWV) alignment by the corresponding station. The heartbeat field indicates that the corresponding station is expected to receive a frame from an access point during ATI and receive a DMG control modulation and a frame from a source DMG station at the time of starting SP or TXOP. The antenna pattern reciprocity field (Antenna Pattern Reciprocity) indicates whether a receiving antenna pattern relevant to AWV is identical to a receiving antenna pattern for the same AWV.

In accordance with an exemplary embodiment, the DMG station capability information may include the non-directional multi-gigabit feedback capability field (Non-DMG Feedback Capability) (A). The Non-DMG Feedback Capability (A) may indicate whether the corresponding STA transmits and receives a signal on the second frequency band. If the corresponding STA receives a signal of the second frequency band on the basis of the Non-DMG Feedback Capability (A), a partner STA receiving a beamforming signal of the corresponding STA in a sector sweep process may transmit a feedback signal using the second frequency band in accordance with an exemplary embodiment. In accordance with an exemplary embodiment, the Non-DMG Feedback Capability (A) may be a flag value indicative of whether or not to receive the second frequency band. Further, in accordance with another exemplary embodiment, the Non-DMG Feedback Capability (A) may be an integer value indicative of whether or not to receive the second frequency band and also indicative of frequency information of the second frequency band. For example, “0” may indicate impossibility to receive the second frequency band, “1” may indicate possibility to receive a 2.5 GHz frequency band, and “2” may indicate possibility to receive a 5 GHz frequency band, but the present disclosure is not limited thereto.

In accordance with an exemplary embodiment, if the Non-DMG Feedback Capability (A) has the flag value and indicates that both STAs exchanging DMG capability information can receive the second frequency band, the STAs may exchange additional information for transmission/reception of the second frequency band. For example, each of the STAs may exchange at least one of frequency information of the second frequency band which can be received by the corresponding STA, identification information of the corresponding STA with respect to the second frequency band, an early termination level (e.g., a signal level satisfying minimum modulation and coding scheme (MCS)) of the corresponding STA, and information indicative of a communication mode (e.g., wireless LAN, Zigbee, NFC, cellular communication, and the like) of the second frequency band. Accordingly, each STA is ready to receive a signal of the second frequency band transmitted by a partner STA.

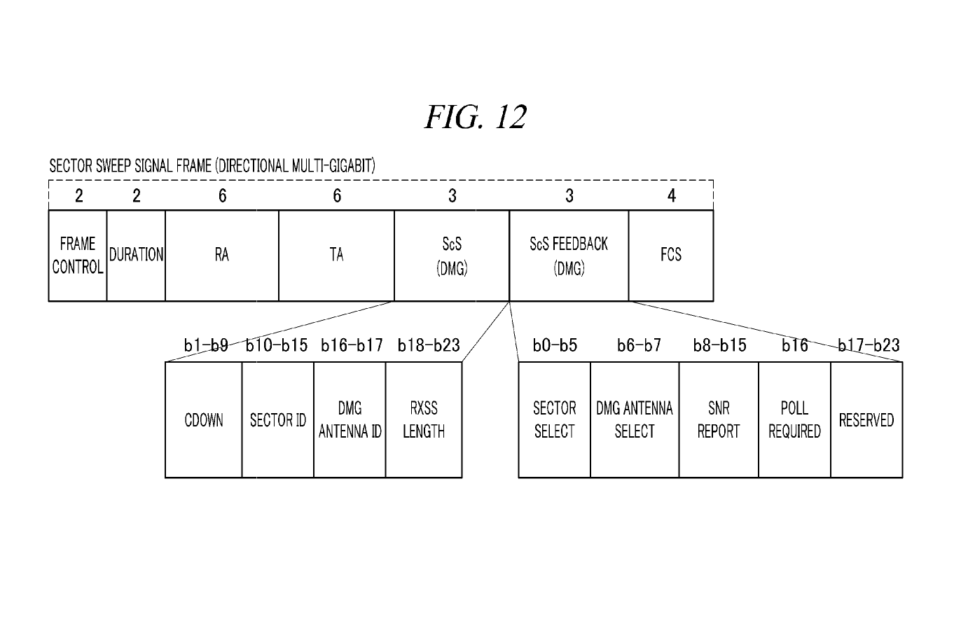

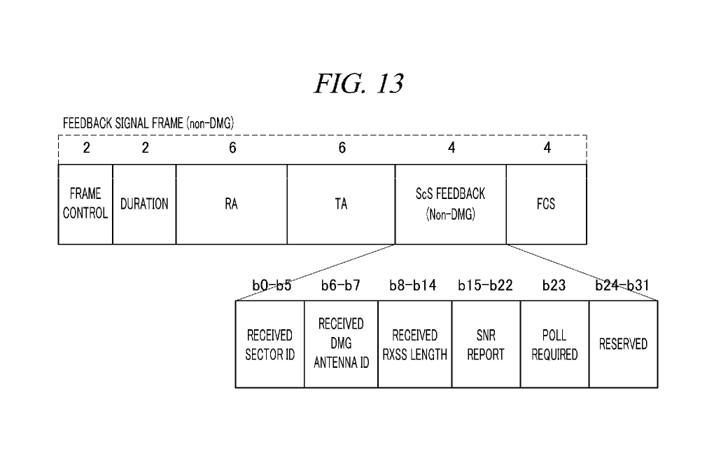

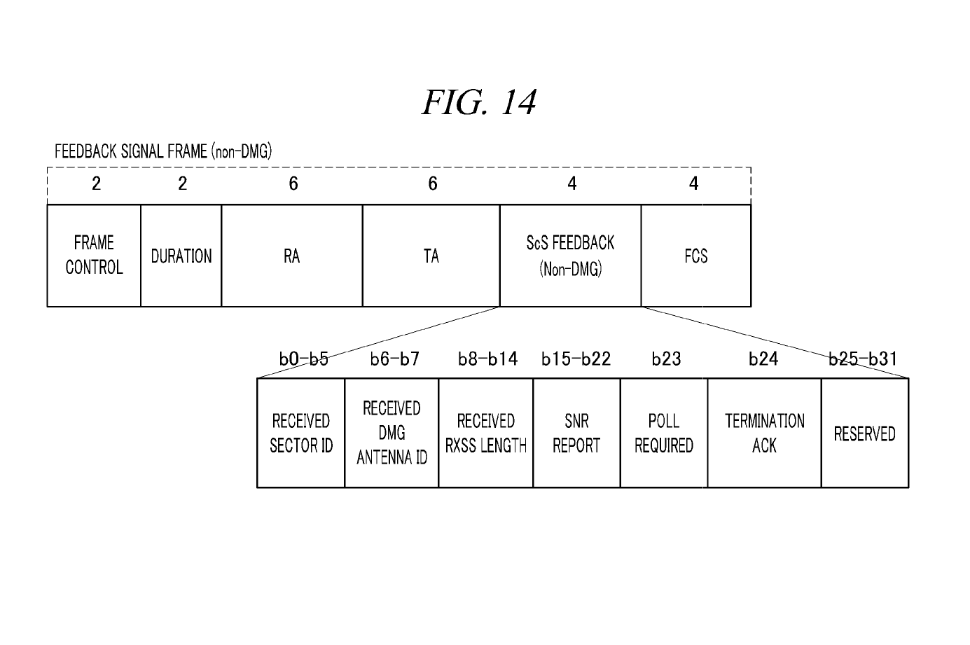

FIG. 12 to FIG. 14 are diagrams showing frame information of a sector sweep signal and a feedback signal corresponding thereto in accordance with an exemplary embodiment. FIG. 12 shows a sector sweep signal (ScS) of the first frequency band (DMG) and a feedback signal (ScS Feedback (DMG)) of the first frequency band, and FIG. 13 and FIG. 14 show feedback signals (ScS Feedback (non-DMG)) of the second frequency band.

Firstly, referring to FIG. 12, a directional multi-gigabit (DMG) sector sweep signal frame includes a frame control field, a duration field for setting a duration, a RA field including a MAC address of the corresponding station as an intended receiver of a sector sweep, a TA field including a MAC address of a receiver station of a sector sweep frame, a sector sweep signal field (ScS), a sector sweep signal feedback field (ScS Feedback), and a frame check sequence field (FCS).

The sector sweep signal (ScS) transmitted using the first frequency band (DMG) may include information on a remaining number of times of beamforming sector sweep (CDOWN), a sector ID, a DMG antenna ID, a RXSS length, and the like. The CDOWN indicates the number of remaining sectors to which a beamforming signal is transmitted after the corresponding sector sweep signal. The sector ID indicates a predetermined identifier of a beam sector that transmits the corresponding sector sweep signal. The DMG antenna ID indicates a predetermined identifier of an antenna that transmits the corresponding sector sweep signal, and may be an identifier indicative of a quasi-omni section of the corresponding sector sweep signal. In accordance with an exemplary embodiment, the sector ID included in a beamforming signal in a sector sweep process may be determined by a combination of the sector ID and the DMG antenna ID in a broad sense.

Further, the feedback signal (ScS Feedback (DMG)) transmitted using the first frequency band may include sector select information (Sector select), DMG antenna select information (DMG Antenna select), signal level information (SNR Report), poll-required information (Poll Required), reserved information, and the like. The feedback signal transmitted using the first frequency band may be transmitted after all sector sweep processes are terminated, and may include information on an optimum sector in the corresponding sector sweep process. The sector select information (Sector select) indicates a sector ID of a specific sector sweep signal having an optimum quality in a previous sector sweep process, and the DMG antenna select information (DMG Antenna select) indicates a DMG antenna ID of the specific sector sweep signal. Further, the signal level information (SNR Report) indicates a reception quality value such as a signal to noise ratio of the specific sector sweep signal.

FIG. 13 shows an exemplary embodiment of a feedback signal (ScS Feedback (non-DMG)) transmitted using the second frequency band. As illustrated, the feedback signal (ScS Feedback (non-DMG)) may include a received sector ID, a received DMG antenna ID, received RXSS length information, signal level information (SNR Report), poll-required information (Poll Required), reserved information, and the like. The feedback signal transmitted using the second frequency band may be transmitted in real time during a sector sweep process. The Received CDOWN, Received Sector ID and Received DMG Antenna ID respectively indicate CDOWN, Sector ID and DMG Antenna ID included in a received sector sweep signal. In accordance with an exemplary embodiment, a sector ID included in the feedback signal (ScS Feedback (non-DMG)) may be determined by a combination of the Received Sector ID and the Received DMG Antenna ID in a broad sense. Further, the SNR Report indicates a reception quality value such as a signal to noise ratio of the specific sector sweep signal. As described above, the feedback signal of the second frequency band may be generated corresponding to each of received sector sweep signals or corresponding to a sector sweep signal that satisfies a predetermined condition. That is, in order to early terminate a sector sweep process in accordance with an exemplary embodiment, the feedback signal of the second frequency band illustrated in FIG. 13 may be generated instead of the feedback signal of the first frequency band illustrated in FIG. 12.

FIG. 14 shows another exemplary embodiment of a feedback signal (ScS Feedback (non-DMG)) transmitted using the second frequency band. Referring to FIG. 14, the feedback signal (ScS Feedback (non-DMG)) of the present disclosure may further include information indicative of early termination of a sector sweep (Termination ACK). That is, the Termination ACK may include information indicative of whether or not to early terminate a sector sweep as a flag value. Further, in order to early terminate a sector sweep process in accordance with another exemplary embodiment, the feedback signal of the second frequency band illustrated in FIG. 14 may be generated instead of the feedback signal of the first frequency band illustrated in FIG. 12.

The wireless LAN system has been described above as an example, but the present disclosure is not limited thereto and can be applied to a cellular communication system in the same manner.

The above description of the present disclosure is provided for the purpose of illustration, and it would be understood by those skilled in the art that various changes and modifications may be made without changing technical conception and essential features of the present disclosure. Thus, it is clear that the above-described embodiments are illustrative in all aspects and do not limit the present disclosure. For example, each component described to be of a single type can be implemented in a distributed manner. Likewise, components described to be distributed can be implemented in a combined manner.

The scope of the present disclosure is defined by the following claims rather than by the detailed description of the embodiment. It shall be understood that all modifications and embodiments conceived from the meaning and scope of the claims and their equivalents are included in the scope of the present disclosure.

We claim:

1. A wireless link configuration method of a station, comprising:
sequentially transmitting a beamforming signal to each of at least one sector, wherein the beamforming signal includes a sector ID for identifying a predetermined sector; and
receiving, from an external station, a feedback signal corresponding to at least one of the transmitted beamforming signals,
wherein the beamforming signal is transmitted on a first frequency band and the feedback signal is received on a second frequency band.

2. The wireless link configuration method of a station of claim 1, further comprising:
determining whether or not to early terminate the step of transmitting before the beamforming signal is transmitted to all sectors on the basis of the received feedback signal.

3. The wireless link configuration method of a station of claim 2,
wherein the determining includes determining whether or not to early terminate the step of transmitting on the basis of a result of a comparison between a signal level included in the received feedback signal and a predetermined early termination level of the station.

4. The wireless link configuration method of a station of claim 2,
wherein the determining includes determining whether or not to early terminate the step of transmitting on the basis of a result of a comparison between a signal level included in any feedback signal and a signal level included in a feedback signal received prior to the any feedback signal.

5. The wireless link configuration method of a station of claim 1,
wherein the feedback signal includes the sector ID and a signal level of a beamforming signal transmitted to a sector corresponding to the sector ID.

6. The wireless link configuration method of a station of claim 1,
wherein the feedback signal is received while a beamforming signal is transmitted to each of the at least one sector.

7. The wireless link configuration method of a station of claim 1,
wherein the first frequency band has a higher frequency than the second frequency band.

8. The wireless link configuration method of a station of claim 7,
wherein the first frequency band is a band of 6 GHz or more and the second frequency band is a band of less than 6 GHz.

9. The wireless link configuration method of a station of claim 1,
wherein the feedback signal is an omnidirectional signal.

10. The wireless link configuration method of a station of claim 2, further comprising:
if it is determined to early terminate the step of transmitting, determining a sector ID for conducting communication with the external station using the first frequency band on the basis of the received feedback signal.

11. The wireless link configuration method of a station of claim 10, further comprising:
if it is determined to early terminate the step of transmitting, setting information on a remaining number of times of beamforming sector sweep (CDOWN) to a predetermined value indicative of early termination of the transmitting of a beamforming signal; and
transmitting the set information on a remaining number of times of beamforming sector sweep as a beamforming signal to a sector corresponding to the determined sector ID.

12. The wireless link configuration method of a station of claim 1, further comprising:
before the step of transmitting of a beamforming signal, exchanging DMG capability information of each of the station and the external station,
wherein the DMG capability information includes information indicative of whether the station or the external station can transmit and receive a signal on the second frequency band.

13. The wireless link configuration method of a station of claim 12,
if the DMG capability information of the station and the DMG capability information of the external information indicate possibility to receive a signal of the second frequency band,
transmitting at least one of frequency information of the second frequency band, identification information of the station with respect to a second frequency, an early termination level of the station, and information indicative of a communication mode of the second frequency band.

14. A wireless link configuration method of a station, comprising:
receiving at least one beamforming signal from an external station, wherein the beamforming signal includes a sector ID for identifying a predetermined sector of the external station; and
transmitting at least one feedback signal to the external station in response to the at least one beamforming signal,
wherein the beamforming signal is received on a first frequency band and the feedback signal is transmitted on a second frequency band.

15. The wireless link configuration method of a station of claim 14, further comprising:
determining whether or not to generate the feedback signal on the basis of the received beamforming signal.

16. The wireless link configuration method of a station of claim 15,
wherein the determining includes determining whether or not to generate the feedback signal on the basis of a result of a comparison between a signal level included in the received beamforming signal and a predetermined early termination level of the station.

17. The wireless link configuration method of a station of claim 15,
wherein the determining includes determining whether or not to generate the feedback signal on the basis of a result of a comparison between a signal level included in any beamforming signal and a signal level included in a feedback signal received prior to the any beamforming signal.

18. The wireless link configuration method of a station of claim 14,
wherein the feedback signal includes information indicative of early termination of the transmitting of a beamforming signal to the external station.

19. A station comprising:
a processor that controls an operation of the station; and
at least one network interface card that transmits or receives data on the basis of an instruction of the processor,
wherein the processor sequentially transmits a beamforming signal to each of at least one sector, wherein the beamforming signal includes a sector ID for identifying a predetermined sector,
the processor receives a feedback signal from an external station in response to at least one of the transmitted beamforming signals, and
the beamforming signal is transmitted on a first frequency band and the feedback signal is received on a second frequency band.
